(19) United States
(12) Patent Application Publication
(10) Pub. No.: US 2025/0307897 A1
(43) Pub. Date: Oct. 2, 2025

(54) TRAVEL ITEM RECOMMENDATIONS VIA INTERACTIVE GENERATIVE AI CHAT INTERFACE

(71) Applicant: Booking.com B.V., Amsterdam (NL)

(72) Inventors: Guy Tomer Nadav, Tel Aviv (IL); Abhishek Gupta, Amstelveen (NL); Pranav Pathak, Amsterdam (NL); Adrienne Marie Enggist, Ilpendam (NL); Rachel Natalie Halimi, Amstelveen (NL); Joseph Erno Futty, Haarlem (NL)

(21) Appl. No.: 18/620,754

(22) Filed: Mar. 28, 2024

(51) Int. Cl. G06Q 30/0601; G06Q 10/02; H04L 51/02

(52) U.S. Cl. CPC G06Q 30/0631; G06Q 10/02; H04L 51/02

(57) ABSTRACT

A computer-implemented method comprises receiving a first chat message at a server computer from a chat interface of a reservation application executing on a mobile computing device; determining, by the server computer, from the first chat message, whether the first chat message specifies an intent for a recommendation of a travel item by programmatically classifying the first chat message to output the intent; in response to determining that the first chat message specifies the intent, generating a first plurality of travel items and a second chat message comprising one or more descriptors of the intent, outputting the first plurality of travel items and the second chat message in the chat interface, and including, in each travel item of the first plurality of travel items, a graphical user interface (GUI) widget that is programmed when selected to initiate a reservation dialog based on the travel item; in response to determining that the first chat message does not specify the intent, outputting in the chat interface a third chat message comprising a prompt for contextual information, receiving, in the chat interface, a fourth chat message specifying the contextual information, executing an inference stage of one or more trained machine-learning models over the contextual information to output one or more named entities, deriving the intent from the first chat message and the one or more named entities, generating, using the server computer, the intent, and the one or more named entities, a second plurality of travel items and a fifth chat message comprising one or more descriptors of the intent, outputting in the chat interface the second plurality of travel items and the fifth chat message, and including, in each of the second travel items, a second GUI widget that is programmed when selected to initiate the reservation dialog based on one or more of the second travel items.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. © 2023 Booking Holdings B.V.

### TECHNICAL FIELD

One technical field of the present disclosure is reservation management systems. Another technical field is generative artificial intelligence (AI). Yet another technical field is chatbot systems.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Reservation management systems may generally include web-based services that provide a selection of travel items that may be suited to diverse users, such as leisure travelers, business travelers, or extended vacationers. Travel items can be hotels or other places of accommodation, destinations or attractions, flights, cruises, cars or other vehicles for rent or hire, or tours. Travel items can be organized using transport itineraries, lodging itineraries, activity itineraries, and so forth. For example, reservation management systems may often include one or more rule-based search engines that may be utilized to return a selection of potential travel itineraries for users in response to users entering text corresponding to a travel item in a search box. A travel item could be a specific destination like a country, a city, a province, an island or islet, or a campsite. A travel item could be a specific lodging or accommodation like a hotel, a cabin, a hostel, or a home-sharing space. A travel item could be a specific means of transport like a flight, a rental car, or a train. A travel item could be a specific attraction like a Kilimanjaro hiking tour, Rainbow Reef snorkeling tour, Amazon rainforests tour, or a French Riviera boat tour.

This approach enables quasi-personalized searches for travel items. However, while a minority of users of reservation management system services may already have in mind a specific travel item or itinerary or otherwise may already be familiar with the destination to which the user is planning to travel, most other users may benefit from having the reservation management system recommend one or more travel itinerary recommendations to the user in a personalized manner. Yet, many existing reservation management systems rely too heavily on users' historical travel itinerary data and the assumption that users will always input their express intent for a specific travel itinerary. For many new users or sporadic users of reservation management system services, the reservation management system may struggle to provide uniquely personalized and contextual travel itinerary recommendations to the new or sporadic user.

Rule-based search engine-powered reservation management systems may be best suited to users who already know a specific travel itinerary or are already familiar with the destination to which the user is planning to travel. Such existing reservation management systems may thus require a user to perform a large number of individual search queries before the reservation management system can even begin to surface or recommend a travel itinerary that may be suited to the desire of the user. Moreover, the large number of individual search queries performed by the user may translate to the reservation management system having to perform a large number of compute-intensive database calls, which, by extension, reduces overall CPU performance and memory storage capacity and increases the data latency of the reservation management system. It may be thus useful to provide techniques to improve reservation management systems.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2 illustrates an example of a generative artificial intelligence (AI) reservation management and orchestration system.

FIG. 3A illustrates an example of a generative AI orchestration system.

FIG. 3B illustrates a natural language processing (NLP) service system.

FIG. 4 illustrates an example recommendation system and pipeline(s).

FIG. 5 illustrates an example workflow diagram for identifying, generating, and providing travel itinerary recommendations in response to natural language requests.

FIG. 6A, FIG. 6B, FIG. 6C illustrates a flow diagram of an example method for identifying, generating, and providing travel itinerary recommendations in response to natural language requests.

FIG. 7 illustrates a computer system with which one embodiment could be implemented.

### DETAILED DESCRIPTION

In the following description, numerous specific details are outlined to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described concerning one or more particular embodiments or drawing figures, but such features are not limited to usage in the one or more particular embodiments or figures concerning which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. General Overview

In one embodiment, a computer-implemented method comprises receiving a first chat message at a server computer from a chat interface of a reservation application executing on a mobile computing device; determining, by the server computer, from the first chat message, whether the first chat message specifies an intent for a recommendation of a travel item by programmatically classifying the first chat message to output the intent; in response to determining that the first chat message specifies the intent, generating a first plurality of travel items and a second chat message comprising one or more descriptors of the intent, outputting the first plurality of travel items and the second chat message in the chat interface, and including, in each travel item of the first plurality of travel items, a graphical user interface (GUI) widget that is programmed when selected to initiate a reservation dialog based on the travel item; in response to determining that the first chat message does not specify the intent, outputting in the chat interface a third chat message comprising a prompt for contextual information, receiving, in the chat interface, a fourth chat message specifying the contextual information, executing an inference stage of one or more trained machine-learning models over the contextual information to output one or more named entities, deriving the intent from the first chat message and the one or more named entities, generating, using the server computer, the intent, and the one or more named entities, a second plurality of travel items and a fifth chat message comprising one or more descriptors of the intent, outputting in the chat interface the second plurality of travel items and the fifth chat message, and including, in each of the second travel items, a second GUI widget that is programmed when selected to initiate the reservation dialog based on one or more of the second travel items.

In various embodiments, the disclosure encompasses the subject matter of the following numbered clauses:

2. The computer-implemented method of Clause 1, wherein programmatically classifying the first chat message to output an intent comprises: executing a first inference stage of one or more trained machine-learning models over the first chat message to output one or more responsive chat messages that respond to the first chat message; executing a second inference stage of one or more second trained machine-learning models over the first chat message to output the intent.

3. The computer-implemented method of Clause 1 further comprising: displaying a home screen interface of the reservation application; receiving, at the server computer and the reservation application, a request to generate the travel items; displaying the chat interface in response to the request.

4. The computer-implemented method of Clause 1, further comprising: receiving, by the server computer, and from the reservation application, a selection of at least one of the second plurality of travel items; in response to receiving the selection, causing the chat interface to display a third plurality of travel items associated with the second plurality of travel items.

5. The computer-implemented method of Clause 4, wherein the second plurality of travel items comprises a plurality of recommendations of one or more travel destinations, and wherein the third plurality of travel items comprises a plurality of recommendations of a lodging, a transport, or an attraction.

6. The computer-implemented method of Clause 3, further comprising: receiving, by the server computer, and from the reservation application, a second request corresponding to a selection of at least one of the third plurality of recommendations; in response to receiving the second request, causing, by the server computer, the reservation application to display the at least one of the third plurality of recommendations, the at least one of the third plurality of recommendations being displayed to prompt a reservation.

7. The computer-implemented method of Clause 1, wherein determining whether the first chat message specifies the intent for the recommendation of a travel item further comprises: inputting the first chat message into a classification model trained to identify an appropriateness of the first chat message; causing, by the server computer, the chat interface to display a sixth chat message, wherein the sixth chat message comprises an indication of the appropriateness of the first chat message.

8. The computer-implemented method of Clause 1, wherein generating the first plurality of travel items or the second plurality of travel items comprises retrieving the first plurality of travel items or the second plurality of travel items from a database utilizing one or more recommendation systems.

9. The computer-implemented method of Clause 8, wherein retrieving the first plurality of travel items or the second plurality of travel items further comprises: generating a retrieval request based on the intent from the first chat message and the one or more named entities; providing the retrieval request to the one or more recommendation systems; retrieving, by the one or more recommendation systems, the first plurality of travel items or the second plurality of travel items from the database based on the retrieval request.

10. The computer-implemented method of Clause 8, wherein the one or more recommendation systems comprise one or more trained machined-learning models.

11. The computer-implemented method of Clause 1, wherein the one or more trained machine-learning models comprise one or more language models (LMs) or one or more large language models (LLMs).

### 2. Structural & Functional Overview

### 2.1 Distributed Computer System Example

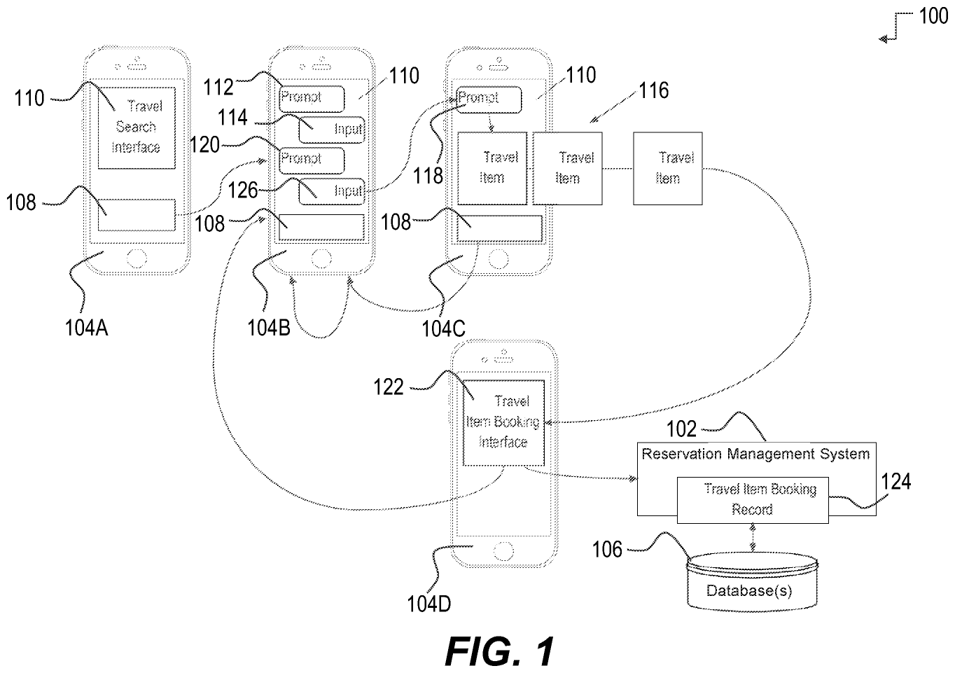

FIG. 1 illustrates a distributed computer system showing the context of use and principal functional elements with which one embodiment could be implemented. In an embodiment, a computing environment 100 includes a reservation management system 102 and one or more mobile computing devices 104A-104D, which may each include components implemented partially by hardware, such as one or more hardware processors executing stored program instructions stored in one or more databases 106 for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of identifying, generating, and providing travel itinerary recommendations in response to natural language requests. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In one embodiment, by identifying, generating, and providing travel itinerary recommendations in response to natural language requests, compute-intensive database queries and server network traffic may be markedly reduced, namely due to the server and database not having to respond to an otherwise large number of superfluous search queries or providing cold-start recommendations as associated with existing reservation management systems. Moreover, by identifying, generating, and providing travel itinerary recommendations in response to natural language requests, overall CPU or GPU performance in execution time, latency, power consumption, and clock speed may all be markedly improved.

In certain embodiments, a computing environment 100 may include a reservation management system 102 and one or more mobile computing devices 104A-104D. For example, in certain embodiments, the reservation management system 102 may include a cloud-based computing architecture suitable for identifying, generating, and providing travel itinerary recommendations in response to natural language requests in an embodiment. For example, in one embodiment, the reservation management system 102 may include a Platform as a Service (PaaS) architecture, a Software as a Service (SaaS) architecture, an Infrastructure as a Service (IaaS) architecture, a Compute as a Service (CaaS) architecture, a Data as a Service (DaaS) architecture, a Database as a Service (DBaaS) architecture, or other similar cloud-based computing architecture.

The reservation management system 102 may include one or more processors, such as a general-purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various travel, lodging, and logistics data and making one or more predictions or decisions based thereon.

In certain embodiments, one or more mobile computing devices 104A-104D may include any devices suitable for allowing users to launch and engage with a reservation management application executing on one or more mobile computing devices 104A-104D. For example, the reservation management application executing on one or more mobile computing devices 104A-104D may be serviced and hosted by the reservation management system 102, which may be coupled to one or more mobile computing devices 104 via a communication network(s), for example. In certain embodiments, the database 106 may include, for example, one or more relational databases or data lakes that may be utilized to store real-time and historical information to be accessed and utilized by the reservation management system 102. Examples of real-time and historical information include travel data, lodging data, logistics data, transport data, map data, destination data, user profile data, user behavioral data, reservation history data, attractions data, and contextual data.

In certain embodiments, as depicted by the mobile computing device 104A, reservation management system 102 may cause the mobile computing device 104A to display a chat interface 110 within the reservation application executing on the mobile computing device 104A. For example, referring to the mobile computing device 104B, the reservation management system 102 may cause the chat interface 110 within the reservation application executing on the mobile computing device 104B to display a prompt 112, which may be utilized to prompt a user of the mobile computing device 104B to input a request via a chat message input bar 108. In certain embodiments, in response to prompt 112, the user may input into the chat message input bar 108 a chat message 114 corresponding to a request.

In one embodiment, the chat message 114 may be programmatically classified by the reservation management system 102 to identify an intent and a named entity for the chat message 114 to satisfy the request. For example, in one embodiment, the chat message 114 may include a request with sufficient contextual information for the reservation management system 102 to identify a user intent and a named entity for the chat message 114, such as “I would like to visit a Caribbean beach this summer.” In another embodiment, the chat message 114 may include a request with insufficient contextual information for the reservation management system 102 to identify the intent and a named entity for the chat message 114, such as “I would like to reserve a trip for this summer.” In this context, and any of the embodiments of the disclosure, contextual information can comprise any one or more digitally stored data items from among chat history, filters, data relating to past trips or system interactions, including travel history and preferences, in-session data, including the specific filters selected for a search such as pool, beach proximity, or ski lift, and any themes selected for prospective travel, such as beach holiday or Italian food. The use of any such data items can occur only if the end-user previously gives input specifying consent for the system to use that data.

Different embodiments can be programmed to identify sufficient contextual information using different rules, heuristics, thresholds, or logical requirements. In one embodiment, determining whether enough contextual information is provided to ascertain user intent and/or whether enough search terms have been accumulated from the conversation is threshold-based and programmed to inspect the number of required words, descriptors, features, or tokens in a conversation. In one embodiment, sufficient contextual information is logically present when a chat conversation has specified the number of travelers, an approximate destination, and approximate travel dates. In other embodiment, sufficient contextual information is logically present when a chat conversation has specified at least one value for Traveler Group, Location Context, Time Context, and Trip Vibes/Themes. Furthermore, in one embodiment, if the chat conversation lacks an express intent concerning user location, known user location data can contribute to the execution of the recommendation pipeline. For example, with prior user consent, data from a mobile device, browser, or other source associated with the user and specifying the user's current location can be passively considered. Such location data can be used to return personalized recommendations based on location, with queries such as: “Show me attractions nearby” or “Show me warm destinations with a beach within 4 hours flights from me.”

Other embodiments can modify these requirements based on other known user contextual information and the needs of a particular functional element of the system. For example, the foregoing information is unnecessary to answer specific questions about a chosen property. Depending on how these requirements are programmed, user chat conversations can involve two to five or more turns or rounds before presenting specific recommended travel items.

In certain embodiments, based on whether the reservation management system 102 may identify an intent and a named entity for the chat message 114, the reservation management system 102 may cause the chat interface 110, within the reservation application executing on the mobile computing device 104B, to display a prompt chat message 120, which may be utilized to prompt a user of the mobile computing device 104B to input a chat message 126 for providing additional contextual information. Otherwise, as further depicted by the mobile computing device 104C, the reservation management system 102 may generate and output travel items 116 and a chat message 118, which may include one or more descriptors of the identified intent and named entity for the chat message 114.

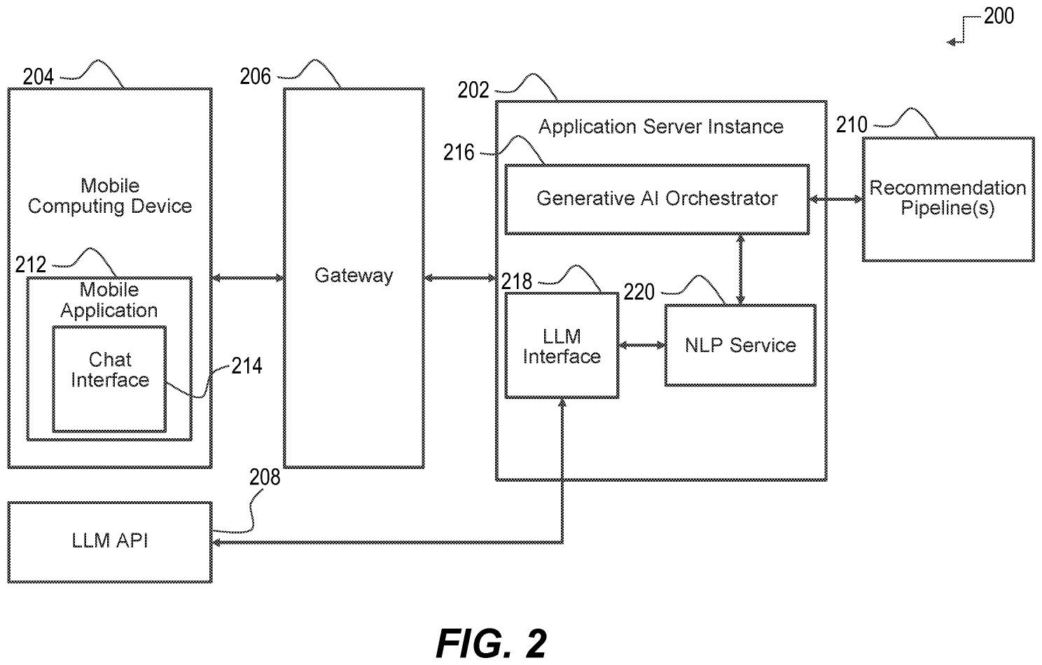

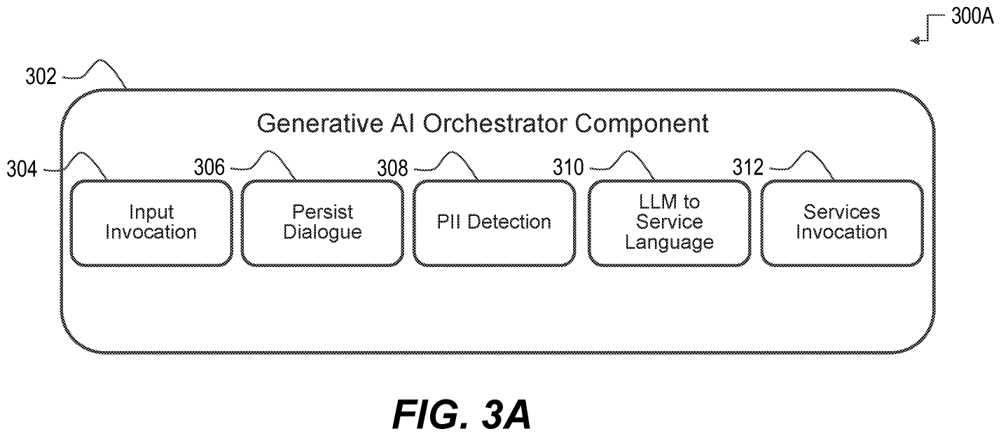

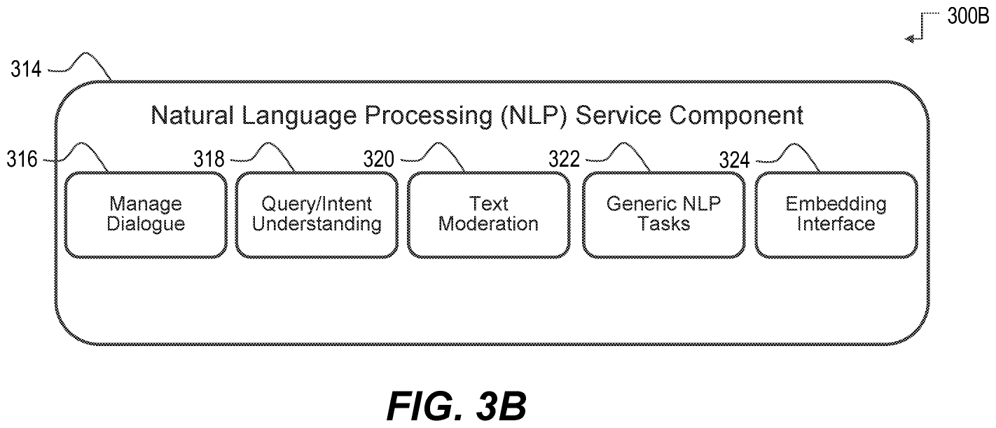

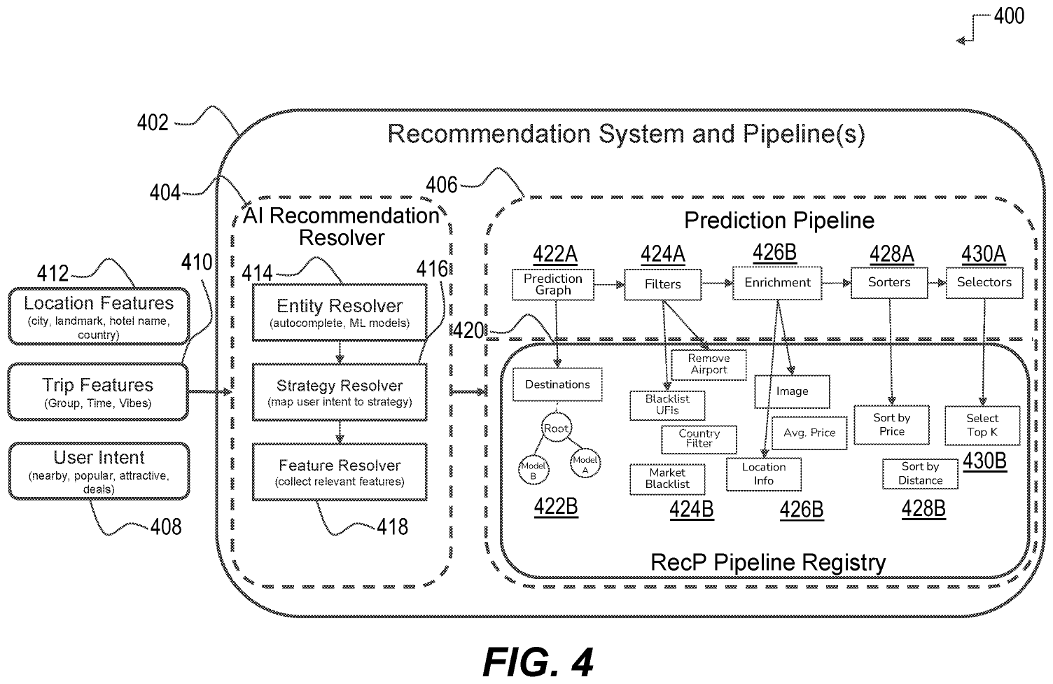

For example, in one embodiment, the number of travel items 116 may include several recommendations of one or more travel destinations and/or one or more recommendations of lodgings or transport. For example, the destination could be a Caribbean beach destination, the lodging recommendation could be a hotel on a Caribbean island, and the transport recommendations could specify flights to the Caribbean region. As will be further appreciated below concerning FIG. 2, FIG. 3A, FIG. 3B, and FIG. 4, for example, the reservation management system 102 may retrieve the number of recommendations of one or more travel destinations and/or one or more recommendations of lodgings or transports from a recommendation system suitable for generating the number of recommendations of one or more travel destinations and/or one or more of recommendations of lodgings or transports.

In certain embodiments, as depicted by the mobile computing device 104D, the number of travel items 116 may each include a GUI widget that may be programmed when selected to initiate a reservation dialog interface 122 based on the selected travel item. For example, when the user selects a travel item corresponding to “Caribbean beach lodging #1,” a GUI widget that may initiate a reservation dialog interface 122 within the reservation application executing on the mobile computing device 104D, thus allowing the user to instantiate a travel item booking record 124 or reservation with “Caribbean beach lodging #1,” for example.

The chat conversation system can be programmed using technical measures or programming techniques to reduce maximum latency in responding to a user prompt. Examples include making the LLM prompt flow asynchronous and splitting the JSON extraction prompts to multiple prompts.

### 2.2 Generative Artificial Intelligence Orchestration System

FIG. 2 illustrates an example of a generative artificial intelligence (AI) reservation management and orchestration system. In an embodiment, the generative AI reservation management and orchestration system 200 may include an application server 202, a mobile computing device 204, a gateway 206, a large language model (LLM) application programming interface (API) 208, and a recommendation system and pipeline(s) 210. In certain embodiments, the mobile computing device 204 may include any computing device suitable for allowing a user to launch and engage with a reservation management application 212 executing on the device 204. In various embodiments, the mobile computing device could be a smartphone, laptop computer, desktop computer, tablet computer, or wearable electronic device. In one embodiment, reservation management application 212 may be a mobile application that can be accessed on a personal electronic device corresponding to a mobile computing device 204. In another embodiment, reservation management application 212 may be a web application that can be accessed via a web browser of a desktop electronic device such as a desktop computer or laptop computer, such as mobile computing device 204.

In certain embodiments, as described below, the reservation management application 212 executing on the mobile computing device 204 may be serviced and hosted by the application server 202. For example, in certain embodiments, the application server 202 may include any AI chatbot application architecture or AI natural language conversational application architecture suitable for identifying, generating, and providing travel itinerary recommendations in response to one or more chat message requests provided by the user via a chat interface 214. The chat interface 214 can comprise a message interface including a message bar and user interface keyboard. For example, in certain embodiments, at runtime, a user may input via chat interface 214 a natural language text sequence corresponding to a request for a reservation of a travel itinerary. In certain embodiments, reservation management application 212, executed on mobile computing device 204, is programmed to provide input in a natural language text sequence corresponding to the user's request for a reservation of a travel itinerary to gateway 206.

In certain embodiments, the gateway 206 may include any hardware system, software system, or some combination of a hardware and software system suitable for pre-processing the input natural language text sequence and routing the input natural language text sequence to the application server 202. As previously noted, in certain embodiments, the application server 202 may include any AI chatbot application architecture or AI natural language conversational application architecture suitable for identifying input natural language text sequence, generating natural language responses to it, and retrieving and providing travel itinerary recommendations corresponding to an identified intent and one or more named entities associated with the input natural language text sequence corresponding to the user's request for a reservation of a travel itinerary.

For example, as further depicted by the generative AI reservation management and orchestration system 200, the application server 202 may include a generative AI orchestrator 216, an LLM interface 218, and a natural language processing (NLP) service component 220. For example, as will be discussed in greater detail below concerning FIG. 3A, the generative AI orchestrator 216 may include an orchestration engine, an intelligent API, or other similar system manager suitable for facilitating user input natural language text sequences and orchestrating services, such as the LLM interface 218, the NLP service component 220, the LLM API 208 and associated external LLM, and the recommendation system and pipeline(s) 210 to understand and identify user intent and to generate a response to the user by way of the reservation management application 212 executing on the mobile computing device 204.

Specifically, as will be discussed in greater detail below concerning FIG. 3B and others, the NLP service component 220 may include machine-learning model-based service utilized for performing linguistic tasks, such as sentiment analysis, information retrieval, information extraction, text summarization, question-answering, tokenization, parts-of-speech tagging, parsing, and so forth that may be associated with providing contextual responses to user input natural language text sequences provided to the application server 202. Similarly, the recommendation system and pipeline(s) 210 may include one or more machine-learning model-based platforms suitable for surfacing and providing recommendations of one or more travel itineraries, such as travel destinations or attractions, accommodations, or means of transport, in a uniquely personalized manner and corresponding to an identified intent and one or more named entities associated with the input natural language text sequence corresponding to the user's request for a reservation of a travel itinerary. In this context, travel destinations can include a country, a city, a province, a region, an island or islet, a campsite, and so forth. Accommodations could include a hotel, a cabin, a hostel, a home-sharing space, and so forth. Means of transport could be a flight reservation, a rental car reservation, a train reservation, a recreational vehicle (RV) reservation, and so forth.

In certain embodiments, upon determining whether an intent and one or more named entities associated with the input natural language text sequence corresponding to the user's request for a reservation of a travel itinerary can be identified, the LLM interface 218 may provide a prompt corresponding to the user's request for a reservation of a travel itinerary to the LLM API 208 and an associated external LLM to generate a context responsive to the input natural language text sequence corresponding to the user's request for a reservation of a travel itinerary. In various embodiments, the LLM API 208 may be associated with generative pre-trained Transformer models like GPT-3.5, GPT-4.0, GPT-4.5, and successor models, other public or networked LLMs, or internal, on-prem, or hosted LLMs.

In one embodiment, the generated response may include a natural language text sequence, including one or more descriptors of an identified input natural language text sequence corresponding to the user's request for a reservation of a travel itinerary. In another embodiment, the generated response may include a natural language text sequence, including a request for additional context information associated with the user's request for a reservation of a travel itinerary.

In certain embodiments, the response generated by the LLM is received at the LLM interface 218 via the LLM API 208. The LLM interface 218 may provide the generated response to gateway 206. In certain embodiments, the gateway 206 is programmed to perform a post-processing of the generated response and route the generated response to the reservation management application 212, which is executed on the mobile computing device 204 and presented to the user by way of the chat interface 214.

### 2.3 Generative Artificial Intelligence Orchestrator

FIG. 3A illustrates an example of a generative AI orchestration system. As depicted, the generative AI orchestration system 300 may include a generative AI orchestrator component 302. In one embodiment, the generative AI orchestrator component 302 may be identical to the generative AI orchestrator 216, as discussed above with respect to FIG. 2. Thus, as generally discussed above, the generative AI orchestrator component 302 may include an orchestration engine, an intelligent API, or other similar system manager suitable for facilitating user input natural language text sequences received from the gateway 206 and orchestrating different underlying services to generate a contextual response.

As depicted by FIG. 3A, in certain embodiments, the generative AI orchestrator component 302 may include an input invocation component 304, a persist dialogue component 306, a personal identification information (PII) detection component 308, an LLM to service language component 310, and a services invocation component 312. For example, in certain embodiments, the input invocation component 304 may include a software service suitable for programmatically calling or invoking, for example, the LLM API 208 and an associated LLM. In certain embodiments, the persist dialogue component 306 may include a software service suitable for storing user input natural language text sequences corresponding to a user's request for a reservation of a travel itinerary and the generated responses, as well as managing the dialogue flow between the user and the external LLM.

In certain embodiments, the PII detection component 308 may include a software service suitable for detecting whenever a user input natural language text sequence does not correspond to a request for a reservation of a travel itinerary or otherwise includes obscene language, hate speech, or other objectional language or text. Similarly, in certain embodiments, the LLM to service language component 310 may include a software service suitable for translating the user input natural language text sequence into a form more understandable or consumable, for example, by the NLP service component 220 and/or the LLM API 208 and an associated external LLM. For example, in one embodiment, the LLM to service language component 310 may be utilized to tokenize the user input natural language text sequence into a sequence of individual tokens.

In certain embodiments, the services invocation component 312 may include a software service suitable for programmatically calling or invoking, for example, the NLP service component 220 and the recommendation system and pipeline(s) 210. In one embodiment, a call to the recommendation system and pipeline(s) 210 comprises a JSON blob resulting from transforming a conversation using a recommendation pipeline JSON prompt. A property recommendation request directed to the recommendation system and pipeline(s) 210 can include main parameters such as intent (the user's recommendation intent that determines the retrieval strategy); user, platform (user and device identifiers); trip (characteristic of the trip like traveler type or booking window); property (property-related information, like filters to apply); and location—where should properties be retrieved from. TABLE 1 shows an example of a structured data request that could be used:

### Table 1—Structured Request to Recommendation System/Pipeline

{
   “use_case”: “genai_tripplanner_chat”,
   “intent”: {
      “rec_type”: “initial”,
      “strategies”: [
         “attractive”
      ],
      “themes”: [ ],
   },
   “user”: {
      “country_code”: “nl”,
      “language_code”: “en”,
      “currency_code”: “USD”
   },
   “platform”: {
      “site_type”: “iphone”,
      “user_os”: “14.4”,
      “user_version”: “28.4-iphone”
   },
   “trip”: {
      “guests”: {
         “total_adults”: 2
      },
      “rooms”: {
         “total”: 1
      },
      “booking window”: {
         “checkin”: “2025-06-03”,
         “checkout”: “2025-06-05”
      },
      “property”: {
         “property_filters”: {
         “breakfast_included_filter”: {“has_breakfast_included”: true},
         }
      },
      “location”: {
         “location_type”: “city”,
         “location_cc1”: “nl”
      }
   },
}

In some embodiments, the services invocation component 312 may be further utilized to execute one or more calls to external services that may be associated with the user's request for a reservation of a travel itinerary, such as a current airline flight schedule, a current weather at a particular destination, local news reports associated with a particular destination, a local time zone associated with a particular destination, a current schedule of “pop-up” attractions associated with a particular destination or lodging, available ride-sharing services associated with a particular destination, available digital payment services associated with a particular destination or lodging, available food services and/or food options associated with a particular destination or lodging, and so forth. Examples of external services include external functions or vector databases.

### 2.4 Natural Language Processing (NLP) Service

FIG. 3B illustrates an example NLP service system 300B. As depicted, the NLP service system 300B may include an NLP service component 314. In one embodiment, the NLP service component 314 may be identical to the NLP service component 220, as discussed above with respect to FIG. 2. Thus, as generally discussed above, the NLP service component 314 may include machine-learning model-based service utilized for performing linguistic tasks, such as sentiment analysis, information retrieval, information extraction, text summarization, question-answering, tokenization, parts-of-speech tagging, parsing, and so forth that may be associated with providing contextual natural language responses to user input natural language text sequences provided to the application server 202, for example.

As depicted by FIG. 3B, in certain embodiments, the NLP service component 314 may include a manage dialogue component 316, a query/intent understanding component 318, a text moderation component 320, a generic NLP tasks component 322, and an embedding interface component 324. In certain embodiments, the manage dialogue component 316 may include a software service suitable for managing the conversational dialogue flows between the user and the LLM by leveraging, for example, one or more statistical models of the NLP service component 314 to exhibit broad world knowledge, linguistic competence, and conversational ability for increasing user experience.

In certain embodiments, the query/intent understanding component 318 may include, for example, a natural language understanding (NLU) service suitable for identifying and classifying intent and one or more named entities associated with the input natural language text sequence corresponding to a user's request for a reservation of a travel itinerary. For example, in certain embodiments, the query/intent understanding component 318 may identify and classify intent and one or more named entities associated with the input natural language text sequence corresponding to a user's request for a reservation of a travel itinerary by interpreting and understanding nuanced meanings, intentions, sentiments, semantics, and contexts embedded within user input natural language text sequences and deducing the user's specific purpose and objective by a given user input natural language text sequence.

In certain embodiments, the text moderation component 320 may include a software service suitable for flagging user-input natural language text sequences that do not correspond to a request for a reservation of a travel itinerary and/or expurgating user-input natural language text sequences that include obscene language, hate speech, or objectionable language. In various embodiments, text moderation component 320 can be programmed to submit a classification-moderation prompt to an LLM to filter out “dirty words.” Alternatively, text moderation component 320 can filter text using proprietary moderation ML models tuned for the travel domain and adhere to enterprise content guidelines. Examples of information that can be moderated or filtered out using appropriately trained models include but are not limited to Customer PII, abusive, racist, and discriminatory content, and content not compliant with brand and policy guidelines.

In certain embodiments, the generic NLP tasks component 322 may include, for example, an NLP service suitable for performing lesser complex NLP tasks, such as tokenization and parsing. In certain embodiments, the embedding interface component 324 may include a software service suitable for embedding a number of disparate interface functions into, for example, a singular interface function.

### 2.5 Recommendation System and Pipeline(s)

FIG. 4 illustrates an example recommendation system and pipeline(s) 400. As depicted, the recommendation system and pipeline(s) 400 may include a recommendation system and pipeline(s) 402. In one embodiment, the recommendation system and pipeline(s) 402 may be identical to the recommendation system and pipeline(s) 210 as discussed above with respect to FIG. 2. Thus, as generally discussed above, the recommendation system and pipeline(s) 402 may include one or more machine-learning model-based platforms suitable for surfacing and providing recommendations of one or more travel itineraries, such as travel destinations, accommodations, means of transport and so forth in a uniquely personalized manner and in accordance with an identified intent and one or more named entities associated with the input natural language text sequence corresponding to a user's request for a reservation of a travel itinerary.

As depicted by FIG. 4, in certain embodiments, the recommendation system and pipeline(s) 402 may include an AI recommendation resolver 404 and a prediction pipeline 406. In certain embodiments, as generally discussed above with respect to the generative AI reservation management and orchestration system 200 of FIG. 2, the recommendation system and pipeline(s) 402 may include a sequence of processes to be performed, for example, once the generative AI orchestrator 216 or generative AI orchestrator component 302 identifies an intent and one or more named entities associated with the input natural language text sequence corresponding to a user's request for a reservation of a travel itinerary. Specifically, in an embodiment, upon identifying an intent and one or more named entities associated with the input natural language text sequence corresponding to a user's request for a reservation of a travel itinerary, the generative AI orchestrator 216 or generative AI orchestrator component 302 may provide a request to the recommendation system and pipeline(s) 402 for recommendations of one or more travel itineraries and retrieve the recommendations of one or more travel itineraries from the recommendation system and pipeline(s) 402.

For example, as depicted by FIG. 4, the recommendation system and pipeline(s) 402 may receive user intent 408, trip features 410, and location or destination features 412. For example, user intent 408 could correspond to a search for a travel itinerary, and the trip features 410 could specify solo travel vs. group travel, leisure travel vs. business travel, time of travel, seasonality, and so forth, and the location or destination features 412 could specify destinations, lodgings, means of transport, attractions, and so forth.

In certain embodiments, the AI recommendation resolver 404 is programmed to apply one or more statistical models or machine-learning models, such as an entity resolver 414, a strategy resolver 416, and a feature resolver 418 to instantiate the prediction and decision-making for what type of recommendations of one or more travel itineraries should be surfaced or retrieved based on the identified intent and one or more named entities associated with the input natural language text sequence corresponding to the user's request for a reservation of a travel itinerary.

In certain embodiments, in response to the AI recommendation resolver 404 determining the type of recommendations of one or more travel itineraries to be surfaced or retrieved based on the user intent 408, the trip features 410, and the location or destination features 412, the AI recommendation resolver is programmed to provide the determination to the prediction pipeline 406. In certain embodiments, the prediction pipeline 406 may be utilized to generate predictions of recommendations of one or more travel itineraries to be provided, for example, to the generative AI orchestrator 216, and, ultimately, to the chat interface 214 of the reservation management application 212 executing on the mobile computing device 204 for display to a user, for example.

In certain embodiments, the prediction pipeline 406 may be associated with a recommendation pipeline registry 420. It may include a prediction graph 422A, one or more filters 424A, a data enrichment component 426A, one or more sorters 428A, and one or more selectors 430A. In certain embodiments, the prediction graph 422A may be utilized, for example, to select one or more machine-learning models 422B best suited for the type of recommendations of one or more travel itineraries to be surfaced or retrieved. For example, in one embodiment, the predictions of recommendations of one or more travel itineraries may be dependent on the complexity of the request, one or more predetermined system constraints, and the available information stored, for example, in the recommendation pipeline registry 420 and/or the one or more databases 106 at runtime. For example, the complexity of the request could involve domestic destinations vs. international destinations, domestic lodgings vs. international lodgings, weekend getaways vs. extended vacations, and so forth, and the system constraints could relate to execution time, load time, latency, and so forth.

In certain embodiments, one or more filters 424A may be utilized, for example, to filter the predictions of recommendations of one or more travel itineraries to only the most relevant predictions associated with the request and remove superfluous information 424B. Similarly, the data enrichment component 426A may be utilized to enrich the predictions of recommendations of one or more travel itineraries with a set of travel itinerary contextual information 426B, such as pricing information, visual image information, location or distance information, translation of content, user personal identity data, and so forth. In certain embodiments, one or more sorters 428A may be utilized, for example, to sort the predictions of recommendations of one or more travel itineraries according to the set of travel itinerary contextual information 426B, such as by distance, pricing, relevance, or other similar information 428B. Lastly, in certain embodiments, the one or more selectors 430A may be utilized to select from the predictions of recommendations of one or more travel itineraries the top K candidate recommendations of one or more travel itineraries that may be selected based on, for example, a generated matching score associated with each of the predictions of recommendations of one or more travel itineraries.

### 2.6 Workflow for Identifying, Generating, and Providing Travel Itinerary Recommendations in Response to Natural Language Requests

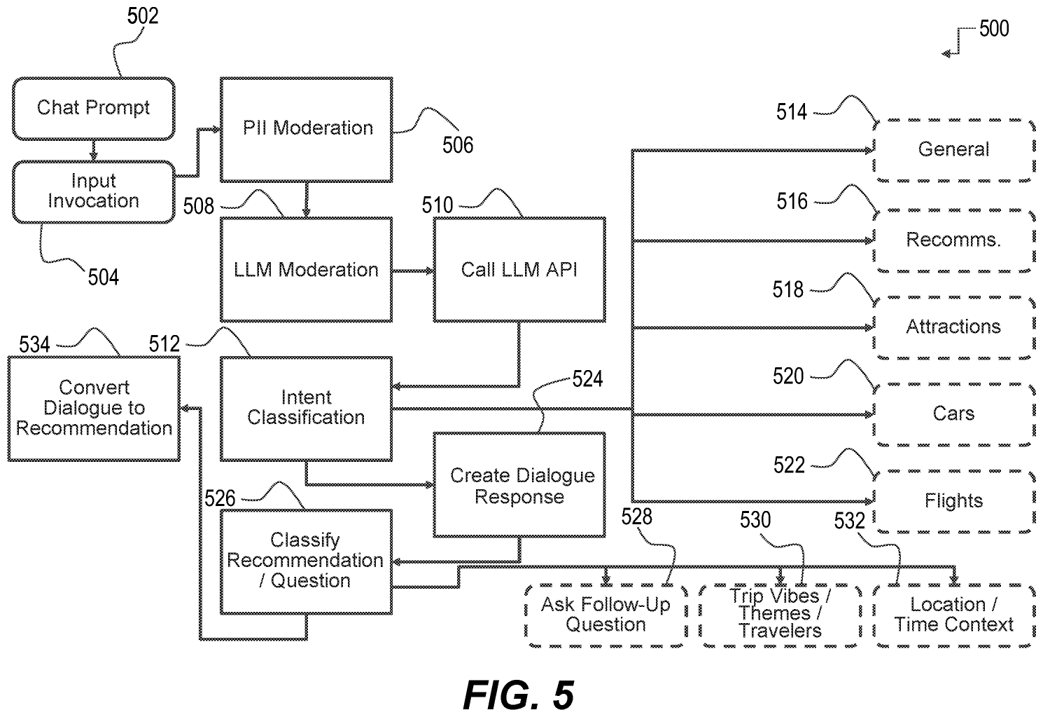

FIG. 5 illustrates an example workflow diagram 500 for identifying, generating, and providing travel itinerary recommendations in response to natural language requests. In an embodiment, the workflow diagram 500 may be executed by the reservation management system 102, as discussed above with respect to FIG. 1, and/or the generative AI reservation management and orchestration system 200, as discussed above concerning FIG. 2. As depicted by FIG. 5, in certain embodiments, the workflow diagram 500 may begin with a chat message prompt 502 being provided to a user. For example, in one embodiment, the reservation management system 102 may cause the chat interface 110 within the reservation application executing on the mobile computing device 104B to display a prompt 112, which may be utilized to prompt a user of the mobile computing device 104B to input a request via a chat message input bar 108.

In certain embodiments, the workflow diagram 500 may continue with an input invocation 504. For example, in one embodiment, in response to prompt 112, the user may input, into the chat message input bar 108, a chat message 114 corresponding to a request. In certain embodiments, the workflow diagram 500 next executes a PII moderation 506 of the chat message 114 corresponding to a request. For example, performing the PII moderation 506 of the chat message 114 may include identifying, for example, any sensitive personal user data and requesting by prompt chat message 120 that the user removes any sensitive personal user data from the chat message 114. Personally identifiable information or other sensitive personal user data can comprise an email address, personal identification number (PIN), physical address, credit card information, and so forth.

In certain embodiments, the workflow diagram 500 is programmed to continue with performing an LLM moderation 508 of the chat message 114 corresponding to a request. For example, in one embodiment, performing the LLM moderation 508 of chat message 114 may include identifying whether the chat message 114 corresponds to a request for a recommendation of a travel itinerary and whether the chat message 114 includes obscene or objectional language and subject matter, and providing a prompt chat message 120 indicating when the chat message 114 corresponds to a request other than a request for a recommendation of a travel itinerary or when the chat message 114 includes obscene or objectional language and subject matter.

In certain embodiments, the workflow diagram 500 may continue with performing a call to an LLM API 510. For example, in certain embodiments, based upon the identification of whether the chat message 114 includes any sensitive personal user data and appropriately corresponds to a request for a recommendation of a travel itinerary, a call may be provided to the LLM API 208 and an associated LLM to generate one or more prompt chat messages 120 in response.

In certain embodiments, the workflow diagram 500 is programmed to continue with performing intent classification 512. For example, in one embodiment, the chat message 114 may be programmatically classified to identify an intent and one or more named entities for the chat message 114 to satisfy the request. In certain embodiments, performing the intent classification 512 may include classifying the intent and one or more named entities of the request as being directed to one or more of a request for general travel information 514, a request for a recommendation of a travel itinerary 516, a request for one or more attractions 518, a request for a ground transport 520, or a request for air transport 522. For example, in one embodiment, the chat message 114 may include a request with sufficient contextual information to identify an intent and a named entity for the chat message 114, such as “I would like to visit a Caribbean beach this summer.” In another embodiment, chat message 114 may include a request with insufficient contextual information to identify an intent and a named entity for the chat message 114, such as “I would like to reserve a trip for this summer.” Processing at the intent classification 512, or query/intent understanding component 318 (FIG. 3B), can use a classification-intent prompt submitted to the API of a public or external LLM, or an internally managed LLM. Multiple LLMs can be used and one or more prompts can be supported to a particular LLM that is chosen to perform best for the component or task.

In certain embodiments, the workflow diagram 500 is programmed to continue with creating a dialogue response 524. For example, in certain embodiments, based on whether an intent and one or more named entities are identified, the chat interface 110 within the reservation application executing on the mobile computing device 104B may display a prompt chat message 120, which may be utilized to prompt a user of the mobile computing device 104B to input a chat message 126 for providing additional contextual information. In certain embodiments, the workflow diagram 500 is programmed to continue with performing recommendation and/or query classification 526. For example, in one embodiment, the intent classification 512 may identify the chat message 114 corresponding to a request as being directed to a request for a recommendation of a travel itinerary 516. In certain embodiments, based on whether sufficient contextual information is associated with the request for a recommendation of a travel itinerary 516, the recommendation of a travel itinerary 516 may be classified as being suggestive of additional follow-up questions 528 for determining travel themes, vibes, and travelers 530 and/or location and time contexts 532. Follow-up questions could request additional contextual information as well.

In certain embodiments, the workflow diagram 500 is programmed to continue with converting the dialogue to a recommendation 534. For example, in response to receiving answers to the additional follow-up questions 528 and determining the travel themes, vibes, and travelers 530 and/or location and time contexts 532, a number of travel items 116 and a chat message 118, which may include one or more descriptors of the identified intent and one or more named entities for the chat message 114, may be generated and outputted. In certain embodiments, the number of travel items 116 may include a number of recommendations of one or more travel destinations and/or recommendations of one or more of lodgings or transports surfaced and retrieved in accordance with the intent and one or more named entities identified with respect to the chat message 114 and/or the chat message 126.

Conversational messaging in this manner can use chains of prompts to the LLM to support prompt abstraction, convo management, and response validation. In an embodiment, block 510 is programmed to use LangChain calls as follows:
1. Using organized prompt templates-ChatPromptTemplate for managing AI and Human messages (SystemMessagePromptTemplate, AIMessagePromptTemplate, HumanMessagePromptTemplate)
2. LLM chain abstraction (from langchain.llms.base import LLM)
3. Memory management ReadOnlySharedMemory, ConversationSummaryBufferMemory—Summarizes in ‘windows’. If there were 10000 tokens in the input and ‘pruned_length_limit’ is 2048, it will call the LLM 5 times.

Embodiments also can use Guardrails calls for validating the JSON schema and parsing, such as JsonSchema and GuardrailsOutputParser.

### 2.7 Method for Identifying, Generating, and Providing Itinerary Recommendations in Response to Natural Language Requests

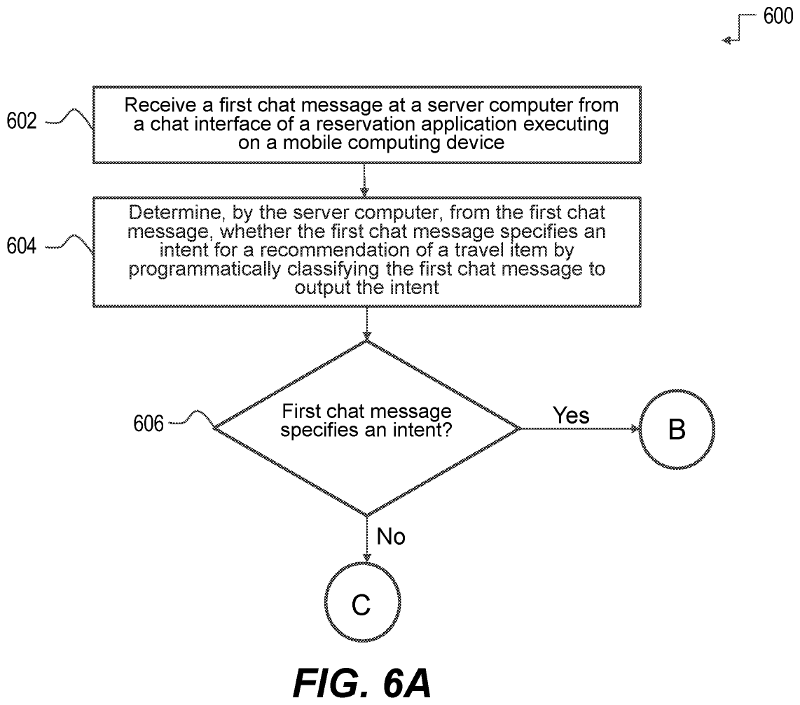

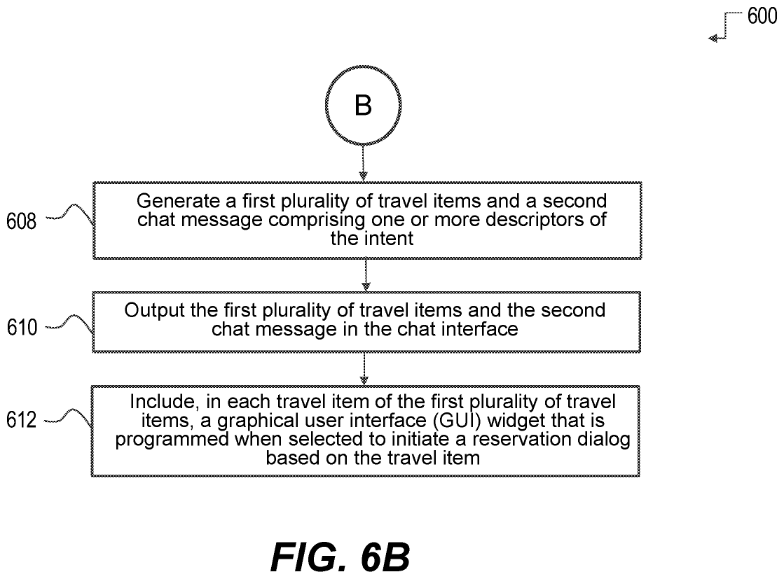

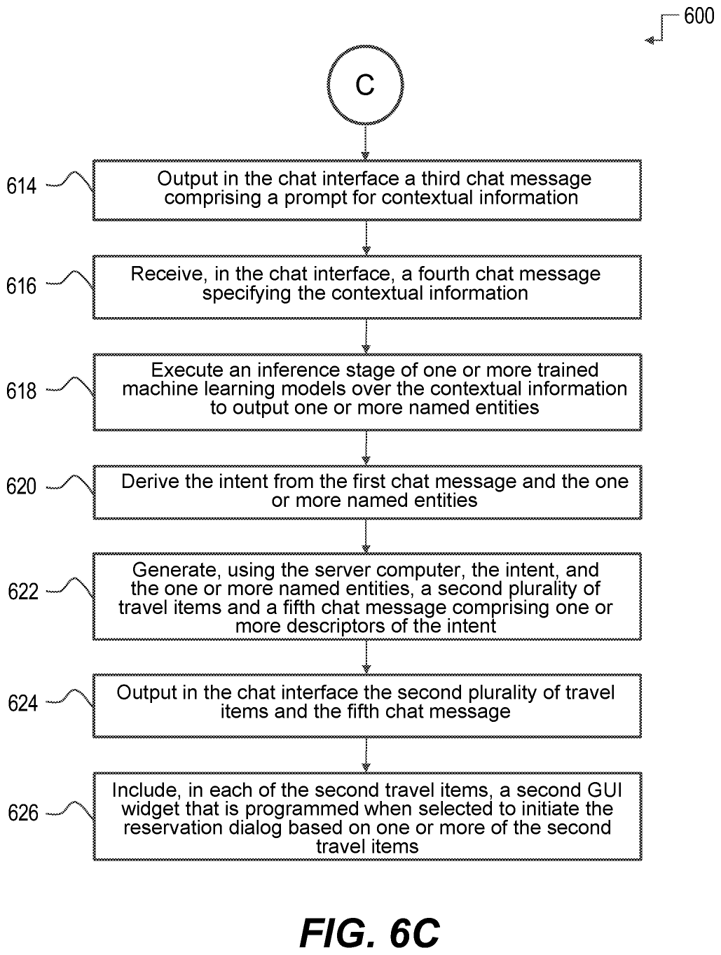

FIG. 6A, FIG. 6B, and FIG. 6C illustrate a flow diagram of a computer-implemented of identifying, generating, and providing travel itinerary recommendations in response to natural language requests. FIG. 6A, FIG. 6B, FIG. 6C, and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

A method 600 may be performed utilizing one or more processing devices, such as one or more processors included as part of the reservation management system 102 as discussed above with respect to FIG. 1, or one or more processors associated with an LLM. The processing devices can include, in various embodiments, hardware processors such as graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various travel, lodging, and logistics data and making one or more predictions or decisions based thereon), firmware or microcode, or some combination thereof. While FIG. 6A, FIG. 6B, and FIG. 6C show one example of method 600, the method also may be executed as a singular and sequential process. Specifically, as will be appreciated, FIG. 6B may include a sub-process executed in response to the illustrated decision 606 being “YES” and FIG. 6C may include a sub-process executed in response to the illustrated decision 606 being “NO.”

Referring first to FIG. 6A, method 600 may begin at block 602 with one or more processing devices receiving a first chat message at a server computer from a chat interface of a reservation application executing on a mobile computing device. For example, in certain embodiments, the reservation management system 102 may cause the mobile computing device 104 to display a chat interface 110 of a reservation application executing on the mobile computing device 104. The method 600 may continue at block 604 with one or more processing devices determining, by the server computer, from the first chat message, whether the first chat message specifies an intent for a recommendation of a travel item by programmatically classifying the first chat message to output the intent.

For example, in certain embodiments, a first prompt 112 may be presented within the chat interface 110 of a reservation application executing on the mobile computing device 104 to prompt the user to input a request. In certain embodiments, in response to the first prompt 112, the user may input a first chat message 114 corresponding to a request, which may be programmatically classified by the reservation management system 102 to identify an intent and a named entity for the first chat message 114 to satisfy the request. For example, in one embodiment, the first chat message 114 may include a request, such as “I would like to visit a Caribbean beach this summer.” In certain embodiments, the reservation management system 102 is programmed to identify an intent for a recommendation for a travel itinerary based on the term “visit’ and identify the named entities as “beach” and “Caribbean beach.”

At block 608, in response to the one or more processing devices determining, at decision 606, that the first chat message 114 specifies an intent for the request at FIG. 6B, method 600 is programmed to generate a first plurality of travel items and a second chat message, including one or more descriptors of the intent. At block 610, the method is programmed to output the first plurality of travel items and the second chat message into the chat interface. In various embodiments, block 608 and block 610 can output a plurality of travel items of different quantities; examples include showing a fixed number of ten travel items, but fewer could be shown depending on available inventory, and in other embodiments, any number from one to dozens could be used.

For example, in certain embodiments, in response to determining that the first chat message 114 specifies an intent for the request, the reservation management system 102 is programmed to generate and output a number of travel items 116 and a second chat message 118, which may include one or more descriptors of the intent. The method 600 is programmed to continue at block 612, at which point the system is programmed to include, in each travel item of the first plurality of travel items, a GUI widget that is programmed when selected to initiate a reservation dialog based on the travel item.

For example, in one embodiment, the number of travel items 116 may include a number of recommendations for one or more travel destinations and/or one or more recommendations for lodgings or transports. In certain embodiments, the number of travel items 116 may each include a GUI widget that may be programmed when selected to initiate a reservation dialog interface 122 based on the selected travel item. For example, when the user selects a travel item corresponding to “Caribbean beach lodging #1,” a GUI widget that may initiate a reservation dialog interface 122 within the reservation application executing on the mobile computing device 104, in which the user can instantiate a travel item booking record 124 or reservation with “Caribbean beach lodging #1.”

Presentation of data via block 610, 612 can occur programmatically using a plurality of services. In an embodiment, when the recommendation pipeline responds to a request, which can include a JSON object specifying a set of features of recommended items, the data is sent through GraphQL to a server that hosts a UI framework that builds the UI; a client such as a browser then renders it. In this manner, programmed services can transform a set of recommendation features to one or more item cards that can appear in the UI.

Returning to decision 606 of FIG. 6A, in response to determining that the first chat message 114 does not specify an intent for the request, at FIG. 6C, method 600 is programmed to continue at block 614 by outputting a third chat message in the chat interface. The third chat message comprises a prompt for contextual information. For example, in one embodiment, the first chat message 114 may include a request, such as “I would like to reserve a trip for this summer.” In certain embodiments, the reservation management system 102 is programmed to identify an intent for a recommendation for a travel itinerary based on the words “reserve” and “trip” but may not be able to identify any named entities associated with the intent for lack of contextual information associated with “trip.”

For example, in certain embodiments, in response to determining that the first chat message 114 does not specify an intent for the request, the reservation management system 102 is programmed to output in the chat interface 110 a third chat message, which includes a second prompt chat message 120 for contextual information, which may be utilized by the reservation management system 102 to identify the intent and named entities of the first chat message 114 corresponding to a request.

At block 616, method 600 is programmed to receive, in the chat interface, a fourth chat message specifying the contextual information. For example, in one embodiment, the first chat message 114 may include a request, such as “I would like to reserve a trip for this summer.” Because the reservation management system 102 may not be able to identify any named entities associated with the intent for lack of contextual information associated with “trip,” the reservation management system 102 may output in the chat interface 110 a third chat message, which includes a second prompt chat message 120 that identifies the intent for a “trip” and requests for contextual information, such as “I can assist you in identifying a destination or lodging for your trip, but what type of trip would you like to take?” In certain embodiments, the user is programmed to input into the chat interface 110 of a reservation application executing on the mobile computing device 104 a fourth chat message 126 specifying the contextual information. For example, in one embodiment, the fourth chat message 126 may include additional contextual information associated with “trip,” such as “I would like to reserve a trip for this summer to a Caribbean beach.”

At block 618, method 600 is programmed to execute an inference stage of one or more trained machine-learning models over the contextual information to output one or more named entities. For example, the user might input into the chat interface 110 of the reservation application executing on the mobile computing device 104 the fourth chat message 126 specifying the contextual information. An example of contextual information could be, “I would like to reserve a trip for this summer to a Caribbean beach.” In response, the reservation management system 102 is programmed to execute one or more trained machine-learning models over the contextual information to output one or more named entities, such as “beach” and “Caribbean beach.”

At block 620, method 600 is programmed to derive the intent from the first chat message and one or more named entities. For example, the reservation management system 102 is programmed to identify an intent for a recommendation for a travel itinerary based on the term “trip’ and identify the named entities “beach” and “Caribbean beach.” The method 600 is programmed to continue at block 622 with the one or more processing devices generating, using the server computer, the intent, and the one or more named entities, a second plurality of travel items and a fifth chat message including one or more descriptors of the intent and at block 624 with the one or more processing devices outputting in the chat interface the second plurality of travel items and the fifth chat message.

For example, in certain embodiments, in response to deriving the intent from the first chat message and the one or more named entities, the reservation management system 102 is programmed to generate and output a number of travel items 116 and a fifth chat message 118, which may include one or more descriptors of the derived intent and the one or more named entities. For example, in one embodiment, the reservation management system 102 may generate and output a number of travel items 116 and a fifth chat message 118, such as “Okay, here are some great Caribbean beaches for your trip this summer.”

At block 626, in an embodiment, the method is programmed to include, in each travel item of the second plurality of travel items, a GUI widget programmed when selected to initiate a reservation dialog based on the travel item. For example, in one embodiment, the number of travel items 116 may include a number of recommendations of one or more travel destinations and/or recommendations of one or more of lodgings or transports. As will be further appreciated below concerning FIG. 2 and FIG. 4, for example, the reservation management system 102 may retrieve the number of recommendations of one or more travel destinations and/or one or more of recommendations of lodgings or transports from a recommendation system suitable for generating the number of recommendations of one or more travel destinations and/or one or more of recommendations of lodgings or transports.

In certain embodiments, the number of travel items 116 may each include a GUI widget that may be programmed when selected to initiate a reservation dialog interface 122 based on the selected travel item. For example, when the user selects a travel item corresponding to “Caribbean beach lodging #1,” a GUI widget that may initiate a reservation dialog interface 122 within the reservation application executing on the mobile computing device 104, in which the user can instantiate a travel item booking record 124 or reservation with “Caribbean beach lodging #1,” for example.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

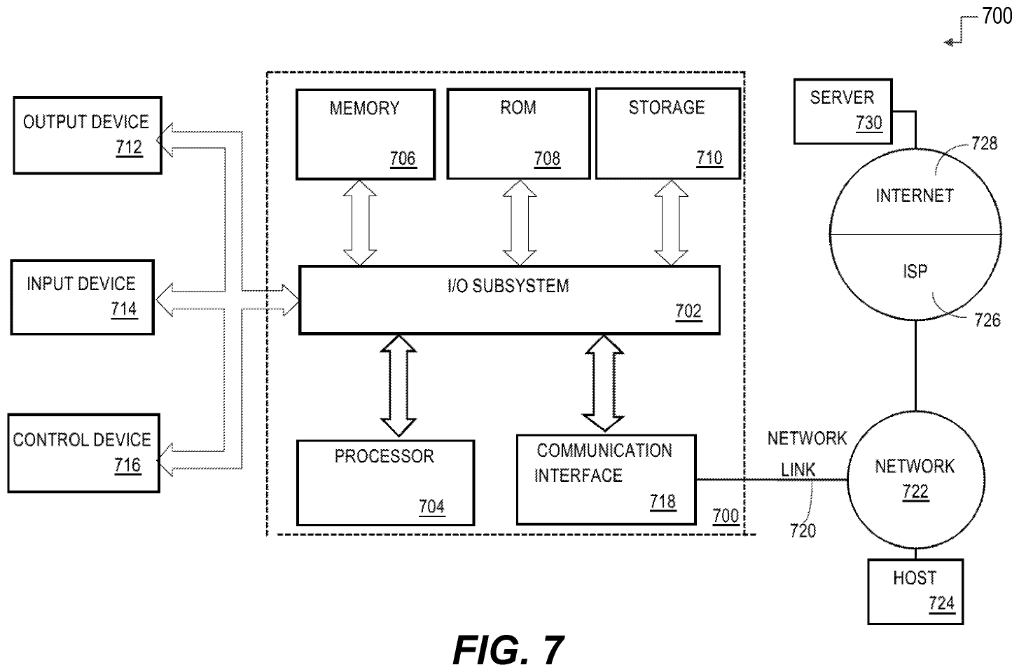

FIG. 7 is a block diagram that illustrates an example computer system with which an embodiment may be implemented. In the example of FIG. 5, a computer system 700 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 700 includes an input/output (I/O) subsystem 702, which may include a bus and/or other communication mechanism(s) for communicating information and/or instructions between the components of the computer system 700 over electronic signal paths. The I/O subsystem 702 may include an I/O controller, a memory controller, and at least one I/O port. The electronic signal paths are represented schematically in the drawings, such as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system, a graphics processing unit (GPU), or a digital signal processor or ARM processor. Processor 704 may comprise an integrated arithmetic logic unit (ALU) or be coupled to a separate ALU.

Computer system 700 includes one or more units of memory 706, such as a main memory, coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during the execution of instructions to be executed by processor 704. Such instructions, when stored in non-transitory computer-readable storage media accessible to processor 704, can render computer system 700 into a special-purpose machine customized to perform the operations specified in the instructions.

Computer system 700 includes non-volatile memory such as read-only memory (ROM) 508 or other static storage devices coupled to I/O subsystem 702 for storing information and instructions for processor 704. The ROM 708 may include various forms of programmable ROM (PROM), such as erasable PROM (EPROM) or electrically erasable PROM (EEPROM). A unit of persistent storage 710 may include various forms of non-volatile RAM (NVRAM), such as FLASH memory, solid-state storage, magnetic disk, or optical disks such as CD-ROM or DVD-ROM and may be coupled to I/O subsystem 702 for storing information and instructions. Storage 710 is an example of a non-transitory computer-readable medium that may be used to store instructions and data which, when executed by the processor 704, cause performing computer-implemented methods to execute the techniques herein.

The instructions in memory 706, ROM 708, or storage 710 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 700 may be coupled via I/O subsystem 702 to at least one output device 712. In one embodiment, output device 712 is a digital computer display. Examples of a display that may be used in various embodiments include a touchscreen display, a light-emitting diode (LED) display, a liquid crystal display (LCD), or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

At least one input device 714 is coupled to I/O subsystem 702 for communicating signals, data, command selections, or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. The control device 716 may be a touchpad, a mouse, a trackball, or cursor direction keys for communicating direction information and command selections to processor 704 and for controlling cursor movement on an output device 712, such as a display. The input device may have at least two degrees of freedom in two axes, a first axis or X axis and a second axis or Y axis, that allows the device to specify positions in a plane. Another type of input device is a wired, wireless, or optical control device such as a joystick, wand, console, steering wheel, pedal, gearshift mechanism, or other control device. An input device 714 may include a combination of multiple input devices, such as a video camera and a depth sensor.

In another embodiment, computer system 700 may comprise an Internet of Things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders, and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware, and interfaces for generating position reporting packets, notifications, pulse or heartbeat signals, or other recurring data transmissions that specify a position of the computer system 700, alone or in combination with other application-specific data, directed toward host computer 724 or server computer 730.

Computer system 700 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire, fiber optics, and wires comprising a bus of I/O subsystem 702. Transmission media can also be acoustic or light waves generated during radio-wave and infrared data communications.

Various forms of media may carry at least one sequence of at least one instruction to processor 704 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to a bus or I/O subsystem 702. Communication interface 718 provides a two-way data communication coupling to a network link(s) 720 directly or indirectly connected to at least one communication network, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line.

Network 722 broadly represents a local area network (LAN), wide-area network (WAN), campus network, internetwork, or any combination thereof. Communication interface 718 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic, or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may connect through network 722 to a host computer 724.

Furthermore, network link 720 may connect through network 722 or to other computing devices via internetworking devices and/or computers operated by an Internet Service Provider (ISP) 726. ISP 726 provides data communication services through a worldwide packet data communication network called Internet 728. A server computer 730 may be coupled to Internet 728. Server computer 730 broadly represents any computer, data center, virtual machine, or virtual computing instance with or without a hypervisor, or computer executing a containerized program system such as DOCKER or KUBERNETES. Server computer 730 may represent an electronic digital service that is implemented using more than one computer or instance and that is accessed and used by transmitting web services requests, uniform resource locator (URL) strings with parameters in HTTP payloads, API calls, app services calls, or other service calls.

Computer system 700 and server computer 730 may form elements of a distributed computing system that includes other computers, a processing cluster, a server farm, or other organizations of computers that cooperate to perform tasks or execute applications or services. Server computer 730 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications.

Server computer 730 may comprise a web application server that hosts a presentation layer, application layer, and data storage layer, such as a relational database system using a structured query language (SQL) or no SQL, an object store, a graph database, a flat file system or other data storage. Computer system 700 can send messages and receive data and instructions, including program code, through the network(s), network link 720, and communication interface 718. In the Internet example, server computer 730 might transmit a requested code for an application program through Internet 728, ISP 726, local network 722, and communication interface 718. The received code may be executed by processor 704 as it is received and/or stored in storage 710 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed.

Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. Accordingly, the specification and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method, comprising:
receiving a first chat message at a server computer from a chat interface of a reservation application executing on a mobile computing device;
determining, by the server computer, from the first chat message, whether the first chat message specifies an intent for a recommendation of a travel item by programmatically classifying the first chat message to output the intent;
in response to determining that the first chat message specifies the intent, generating a first plurality of travel items and a second chat message comprising one or more descriptors of the intent, outputting the first plurality of travel items and the second chat message in the chat interface, and including, in each travel item of the first plurality of travel items, a graphical user interface (GUI) widget that is programmed when selected to initiate a reservation dialog based on the travel item;
in response to determining that the first chat message does not specify the intent, outputting in the chat interface a third chat message comprising a prompt for contextual information,
receiving, in the chat interface, a fourth chat message specifying the contextual information,
executing an inference stage of one or more trained machine-learning models over the contextual information to output one or more named entities,
deriving the intent from the first chat message and the one or more named entities,
generating, using the server computer, the intent, and the one or more named entities, a second plurality of travel items and a fifth chat message comprising one or more descriptors of the intent,
outputting in the chat interface the second plurality of travel items and the fifth chat message, and including, in each of the second travel items, a second GUI widget that is programmed when selected to initiate the reservation dialog based on one or more of the second travel items.

2. The computer-implemented method of claim 1, wherein programmatically classifying the first chat message to output an intent comprises:
executing a first inference stage of one or more first trained machine-learning models over the first chat message to output one or more responsive chat messages that respond to the first chat message;
executing a second inference stage of one or more second trained machine-learning models over the first chat message to output the intent.

3. The computer-implemented method of claim 1, further comprising:
displaying a home screen interface of the reservation application;
receiving, at the server computer, and the reservation application, a request to generate the travel items;
displaying the chat interface in response to the request.

4. The computer-implemented method of claim 1, further comprising:
receiving, by the server computer, and from the reservation application, a selection of at least one of the second plurality of travel items;
in response to receiving the selection, causing the chat interface to display a third plurality of travel items associated with the second plurality of travel items.

5. The computer-implemented method of claim 4, wherein the second plurality of travel items comprises a plurality of recommendations of one or more travel destinations, and wherein the third plurality of travel items comprises a plurality of recommendations of a lodging, a transport, or an attraction.

6. The computer-implemented method of claim 3, further comprising:
receiving, by the server computer, and from the reservation application, a second request corresponding to a selection of at least one of the third plurality of recommendations;
in response to receiving the second request, causing, by the by the server computer, the reservation application to display the at least one of the third plurality of recommendations, the at least one of the third plurality of recommendations being displayed to prompt a reservation.

7. The computer-implemented method of claim 1, wherein determining whether the first chat message specifies the intent for the recommendation of a travel item further comprises:
inputting the first chat message into a classification model trained to identify an appropriateness of the first chat message;
causing, by the server computer, the chat interface to display a sixth chat message, wherein the sixth chat message comprises an indication of the appropriateness of the first chat message.

8. The computer-implemented method of claim 1, wherein generating the first plurality of travel items or the second plurality of travel items comprises retrieving the first plurality of travel items or the second plurality of travel items from a database utilizing one or more recommendation systems.

9. The computer-implemented method of claim 8, wherein retrieving the first plurality of travel items or the second plurality of travel items further comprises:
generating a retrieval request based on the intent from the first chat message and the one or more named entities;
providing the retrieval request to the one or more recommendation systems;
retrieving, by the one or more recommendation systems, the first plurality of travel items or the second plurality of travel items from the database based on the retrieval request.

10. The computer-implemented method of claim 8, wherein the one or more recommendation systems comprise one or more trained machined-learning models.

11. The computer-implemented method of claim 1, wherein the one or more trained machine-learning models comprise one or more language models (LMs) or one or more large language models (LLMs).

12. A reservation management system associated with a reservation service, the reservation management system comprising:
one or more non-transitory computer-readable storage media including instructions;
one or more processors coupled to the storage media, the one or more processors configured to execute the instructions to:
receive a first chat message at a server computer from a chat interface of a reservation application executing on a mobile computing device;
determine, by the server computer, from the first chat message, whether the first chat message specifies an intent for a recommendation of a travel item by programmatically classifying the first chat message to output the intent;
in response to determining that the first chat message specifies the intent, generate a first plurality of travel items and a second chat message comprising one or more descriptors of the intent, output the first plurality of travel items and the second chat message in the chat interface, and include, in each travel item of the first plurality of travel items, a graphical user interface (GUI) widget that is programmed when selected to initiate a reservation dialog based on the travel item;
in response to determining that the first chat message does not specify the intent, output in the chat interface a third chat message comprising a prompt for contextual information,
receive, in the chat interface, a fourth chat message specifying the contextual information,
execute an inference stage of one or more trained machine-learning models over the contextual information to output one or more named entities,
derive the intent from the first chat message and the one or more named entities,
generate, using the server computer, the intent, and the one or more named entities, a second plurality of travel items and a fifth chat message comprising one or more descriptors of the intent,
output in the chat interface the second plurality of travel items and the fifth chat message, and include, in each of the second travel items, a second GUI widget that is programmed when selected to initiate the reservation dialog based on one or more of the second travel items.

13. The reservation management system of claim 12, wherein the instructions to programmatically classify the first chat message to output an intent further comprise instructions to:
execute a first inference stage of one or more first trained machine-learning models over the first chat message to output one or more responsive chat messages that respond to the first chat message;
execute a second inference stage of one or more second trained machine-learning models over the first chat message to output the intent.

14. The reservation management system of claim 12, wherein the instructions further comprise instructions to:
display a home screen interface of the reservation application;
receive, at the server computer, and the reservation application, a request to generate the travel items;
display the chat interface in response to the request.

15. The reservation management system of claim 12, wherein the instructions further comprise instructions to:
receive, by the server computer, and from the reservation application, a selection of at least one of the second plurality of travel items;
in response to receiving the selection, cause the chat interface to display a third plurality of travel items associated with the second plurality of travel items.

16. The reservation management system of claim 15, wherein the second plurality of travel items comprises a plurality of recommendations of one or more travel destinations, and wherein the third plurality of travel items comprises a plurality of recommendations of a lodging, a transport, or an attraction.

17. The reservation management system of claim 15, wherein the instructions further comprise instructions to:
receive, by the server computer, and from the reservation application, a second request corresponding to a selection of at least one of the third plurality of recommendations;
in response to receiving the second request, cause, by the by the server computer, the reservation application to display the at least one of the third plurality of recommendations, the at least one of the third plurality of recommendations being displayed to prompt a reservation.

18. The reservation management system of claim 12, wherein the instructions to determine whether the first chat message specifies the intent for the recommendation of a travel item further comprise instructions to:
input the first chat message into a classification model trained to identify an appropriateness of the first chat message;
cause, by the server computer, the chat interface to display a sixth chat message, wherein the sixth chat message comprises an indication of the appropriateness of the first chat message.

19. The reservation management system of claim 12, wherein the instructions to generate the first plurality of travel items or the second plurality of travel items further comprise instructions to retrieve the first plurality of travel items or the second plurality of travel items from a database utilizing one or more recommendation systems.

20. The reservation management system of claim 19, wherein the instructions to retrieve the first plurality of travel items or the second plurality of travel items further comprise instructions to:
generate a retrieval request based on the intent from the first chat message and the one or more named entities;
provide the retrieval request to the one or more recommendation systems;
retrieve, by the one or more recommendation systems, the first plurality of travel items or the second plurality of travel items from the database based on the retrieval request.

21. The reservation management system of claim 19, wherein the one or more recommendation systems comprise one or more trained machined-learning models.

22. The reservation management system of claim 12, wherein the one or more trained machine-learning models comprise one or more language models (LMs) or one or more large language models (LLMs).

23. A non-transitory computer-readable medium comprising instructions that, when executed by one or more processors of a reservation management system associated with a reservation service, cause the one or more processors to:
receive a first chat message at a server computer from a chat interface of a reservation application executing on a mobile computing device;
determine, by the server computer, from the first chat message, whether the first chat message specifies an intent for a recommendation of a travel item by programmatically classifying the first chat message to output the intent;
in response to determining that the first chat message specifies the intent, generate a first plurality of travel items and a second chat message comprising one or more descriptors of the intent, output the first plurality of travel items and the second chat message in the chat interface, and include, in each travel item of the first plurality of travel items, a graphical user interface (GUI) widget that is programmed when selected to initiate a reservation dialog based on the travel item;
in response to determining that the first chat message does not specify the intent, output in the chat interface a third chat message comprising a prompt for contextual information,
receive, in the chat interface, a fourth chat message specifying the contextual information,
execute an inference stage of one or more trained machine-learning models over the contextual information to output one or more named entities,
derive the intent from the first chat message and the one or more named entities,
generate, using the server computer, the intent, and the one or more named entities, a second plurality of travel items and a fifth chat message comprising one or more descriptors of the intent,
output in the chat interface the second plurality of travel items and the fifth chat message, and include, in each of the second travel items, a second GUI widget that is programmed when selected to initiate the reservation dialog based on one or more of the second travel items.

24. The reservation management system of claim 23, wherein the instructions to programmatically classify the first chat message to output an intent further comprise instructions to:
execute a first inference stage of one or more first trained machine-learning models over the first chat message to output one or more responsive chat messages that respond to the first chat message;
execute a second inference stage of one or more second trained machine-learning models over the first chat message to output the intent.

25. The non-transitory computer-readable medium of claim 23, wherein the instructions further comprise instructions to:
display a home screen interface of the reservation application;
receive, at the server computer, and the reservation application, a request to generate the travel items;
display the chat interface in response to the request.

26. The non-transitory computer-readable medium of claim 23, wherein the instructions further comprise instructions to:
receive, by the server computer, and from the reservation application, a selection of at least one of the second plurality of travel items;
in response to receiving the selection, cause the chat interface to display a third plurality of travel items associated with the second plurality of travel items.

27. The non-transitory computer-readable medium of claim 26, wherein the second plurality of travel items comprises a plurality of recommendations of one or more travel destinations, and wherein the third plurality of travel items comprises a plurality of recommendations of a lodging, a transport, or an attraction.

28. The non-transitory computer-readable medium of claim 26, wherein the instructions further comprise instructions to:
receive, by the server computer, and from the reservation application, a second request corresponding to a selection of at least one of the third plurality of recommendations;
in response to receiving the second request, cause, by the by the server computer, the reservation application to display the at least one of the third plurality of recommendations, the at least one of the third plurality of recommendations being displayed to prompt a reservation.

29. The non-transitory computer-readable medium of claim 23, wherein the instructions to determine whether the first chat message specifies the intent for the recommendation of a travel item further comprise instructions to:
input the first chat message into a classification model trained to identify an appropriateness of the first chat message;
cause, by the server computer, the chat interface to display a sixth chat message, wherein the sixth chat message comprises an indication of the appropriateness of the first chat message.

30. The non-transitory computer-readable medium of claim 23, wherein the instructions to generate the first plurality of travel items or the second plurality of travel items further comprise instructions to retrieve the first plurality of travel items or the second plurality of travel items from a database utilizing one or more recommendation systems.

31. The non-transitory computer-readable medium of claim 30, wherein the instructions to retrieve the first plurality of travel items or the second plurality of travel items further comprise instructions to:
generate a retrieval request based on the intent from the first chat message and the one or more named entities;
provide the retrieval request to the one or more recommendation systems;
retrieve, by the one or more recommendation systems, the first plurality of travel items or the second plurality of travel items from the database based on the retrieval request.

32. The non-transitory computer-readable medium of claim 30, wherein the one or more recommendation systems comprise one or more trained machined-learning models.

33. The non-transitory computer-readable medium of claim 23, wherein the one or more trained machine-learning models comprise one or more language models (LMs) or one or more large language models (LLMs).
